(19) United States
(12) Patent Application Publication
(10) Pub. No.: US 2018/0209176 A1
(43) Pub. Date: Jul. 26, 2018

(54) DOOR LOCK CONTROLLING DEVICE

(71) Applicant: Che-Ming KU, Taipei City (TW)

(72) Inventor: Che-Ming KU, Taipei City (TW)

(21) Appl. No.: 15/879,131

(22) Filed: Jan. 24, 2018

(30) Foreign Application Priority Data
Jan. 26, 2017 (CN) 201710061752.2

(51) Int. Cl. E05B 65/10; E05B 1/00; E05B 47/00

(52) U.S. Cl. CPC E05B 65/108; E05B 1/0053; E05B 2047/0022; E05B 2047/0091; E05B 47/0012

(57) ABSTRACT

A door lock controlling device is adapted to be disposed between a door and a push bar which is mounted on the door and which is operable between locked and unlocked positions. The door lock controlling device includes a belt and a rolling unit. The belt is adapted for extending around the push bar, and has a fixed end adapted to be fixedly secured to the door, and a movable end. The fixed end and the movable end are adapted to be respectively located at opposite sides of the push bar. The rolling unit is adapted to be mounted to the door, and includes a rolling member that is connected to the movable end, and that is rotatable in a rotational direction to roll the belt such that the push bar is depressed by the belt to the unlocked position.

### CROSS-REFERENCE TO RELATED APPLICATION

This application claims priority of Chinese Patent Application No. 201710061752.2, filed on Jan. 26, 2017.

### FIELD

The disclosure relates to a controlling device, and more particularly to a door lock controlling device.

### BACKGROUND

A conventional door lock controlling device is typically mounted to a door of an emergency exit in a building, and faces the interior of the building so that the door opens outward. When an emergency situation occurs, people in the interior of the building can escape by simply pushing a push bar, which is mounted on the door and connected to the conventional door lock controlling device, for releasing a lock mechanism of the conventional door lock controlling device. Such design eliminates the need to use a key to release the lock mechanism, thereby saving time during the escape.

However, sometime it is desired to open the door without having to push the push bar, especially for people in wheelchairs or for those who want to enter the interior of the building from outside the building. Therefore, there is room for improving the conventional door lock controlling device to conveniently release the lock mechanism.

### SUMMARY

Therefore, an object of the disclosure is to provide a door lock controlling device that can alleviate at least one of the drawbacks of the prior art.

According to the disclosure, the door lock controlling device is adapted to be disposed between a door and a push bar which is mounted on the door. The push bar is operable between a locked position, where the push bar is distal from the door and the door is locked, and an unlocked position, where the push bar is proximate to the door to release locking of the door. The door lock controlling device includes a belt and a rolling unit.

The belt is adapted for extending around the push bar, and has a fixed end that is adapted to be fixedly secured to the door, and a movable end that is opposite to the fixed end. The fixed end and the movable end are adapted to be respectively located at opposite sides of the push bar. The rolling unit is adapted to be mounted to the door, and includes a rolling member that is connected to the movable end of the belt, and that is rotatable in a rotational direction to roll the belt such that the push bar is depressed by the belt to the unlocked position.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating a first embodiment of a door lock controlling device according to the disclosure mounted to a door and connected to a push bar;

FIG. 2 is a schematic side view illustrating movement of the push bar between a locked position and an unlocked position via the first embodiment;

FIG. 3 is a partly exploded perspective view illustrating the first embodiment;

FIG. 4 is a block diagram illustrating a circuit unit of the first embodiment;

FIG. 5 is a partly exploded perspective view of a planetary gear mechanism, a coupling mechanism and a drive motor of a rolling unit of the first embodiment;

FIG. 6 is a partly exploded perspective view illustrating the planetary gear mechanism, the coupling mechanism and the drive motor from another angle;

FIG. 7 is a schematic perspective partly cutaway view of a rolling unit of the first embodiment, illustrating the coupling mechanism in an engaging state;

FIG. 8 is a schematic side view of the first embodiment, illustrating operation of the planetary gear mechanism when the coupling mechanism is in the engaging state;

FIG. 9 is a view similar to FIG. 7, but illustrating the coupling mechanism in a disengaging state;

FIG. 10 is a view similar to FIG. 8, but illustrating operation of the planetary gear mechanism when the coupling mechanism is in the disengaging state;

FIG. 11 is a perspective view illustrating the first embodiment connected to another type of push bar;

FIG. 12 is a perspective view illustrating a second embodiment of the door lock controlling device according to the disclosure mounted to a door and connected to a push bar;

FIG. 13 is a partly exploded perspective view of the second embodiment;

FIG. 14 is another partly exploded perspective view of the second embodiment;

FIG. 15 is an enlarged perspective view of a planetary gear mechanism, a drive motor, and a coupling mechanism of a rolling unit of the second embodiment;

FIG. 16 is a fragmentary exploded perspective view of the second embodiment;

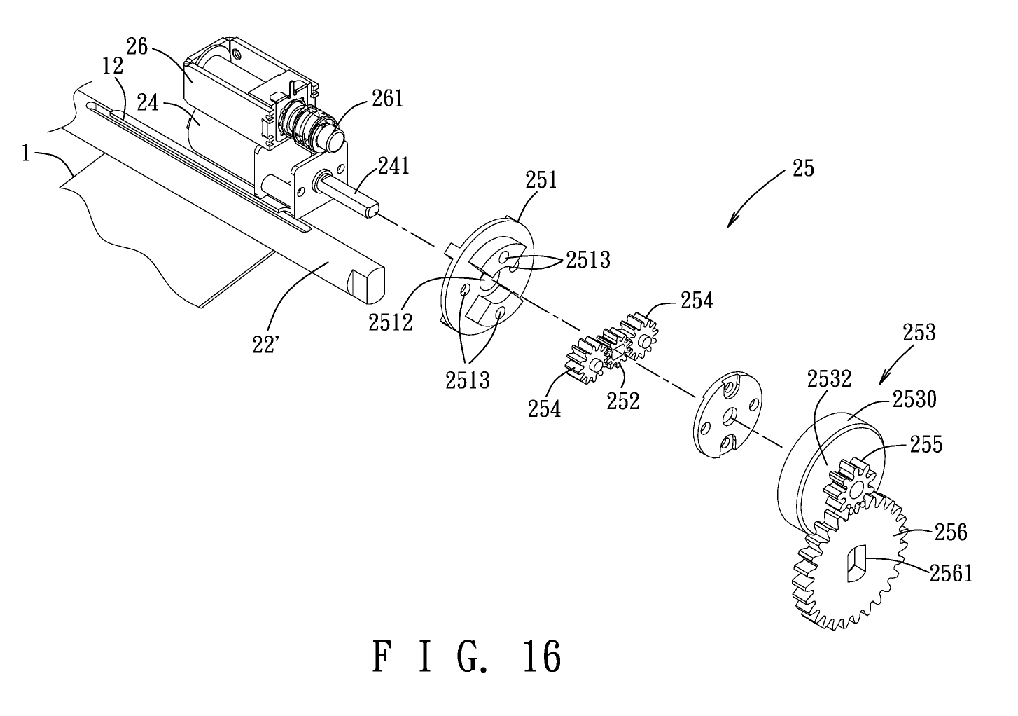

FIG. 17 is a fragmentary exploded perspective view illustrating the second embodiment from another angle;

FIG. 18 is a perspective view illustrating the second embodiment being connected to the push bar of FIG. 1;

FIG. 19 is a perspective view of a fixed reel of a third embodiment of the door lock controlling device according to the disclosure;

FIG. 20 is an exploded perspective view of the fixed reel of the third embodiment; and

FIG. 21 is a sectional view of the fixed reel taken along line XXI-XXI in FIG. 19.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

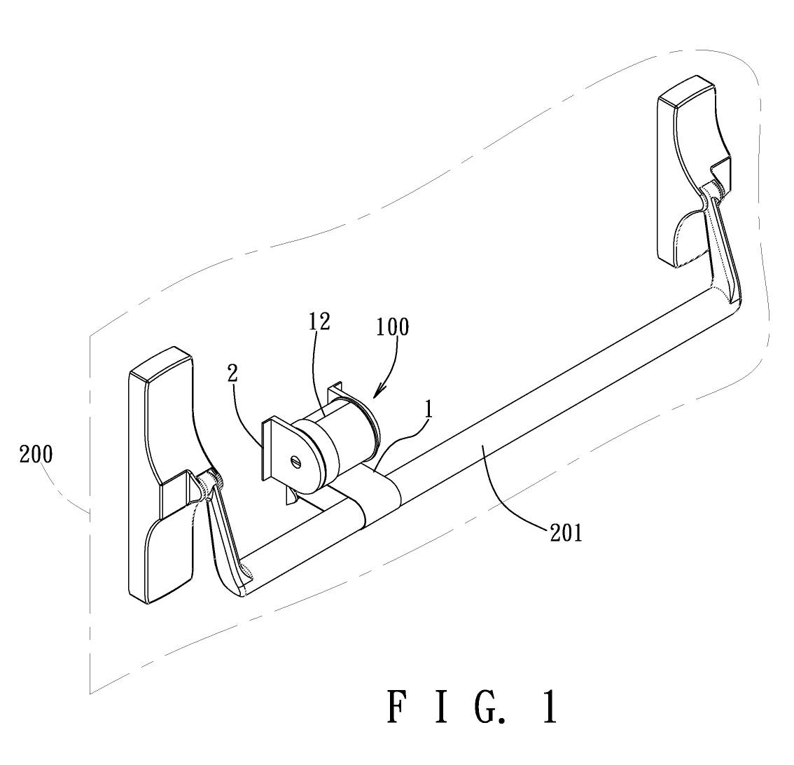

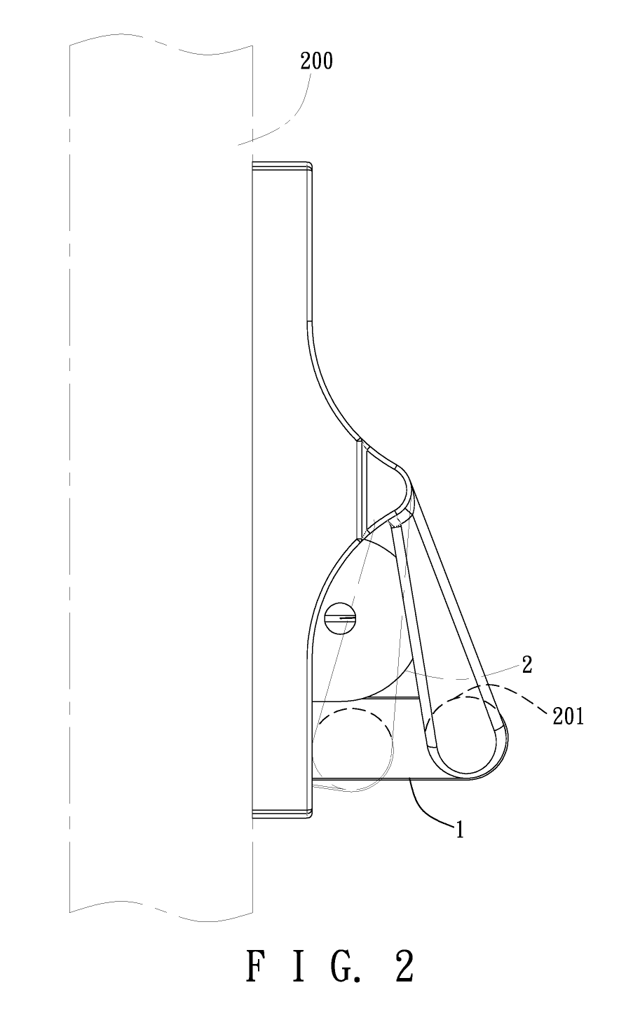

Referring to FIGS. 1 and 2, a first embodiment of a door lock controlling device 100 is adapted to be disposed between a door 200 and a push bar 201 which is mounted on the door 200. As shown in FIG. 2, the push bar 201 is operable between a locked position (illustrated in solid lines), where the push bar 201 is distal from the door 200 and the door 200 is locked, and an unlocked position (illustrated in dashed lines), where the push bar 201 is proximate to the door 200 to release locking of the door 200.

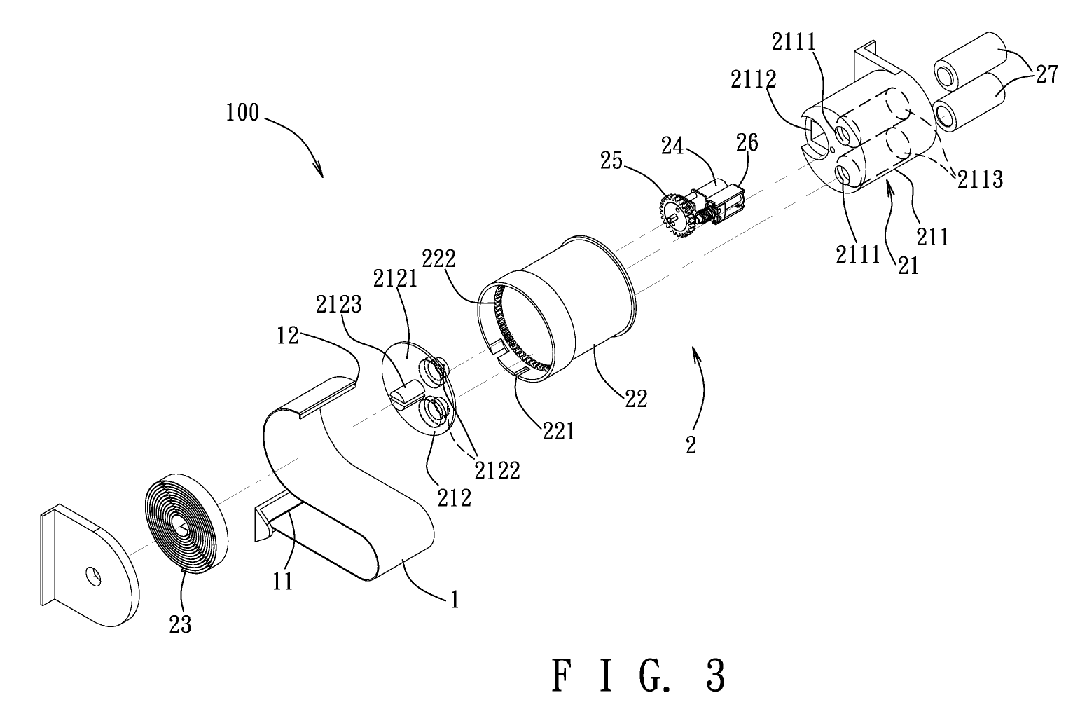

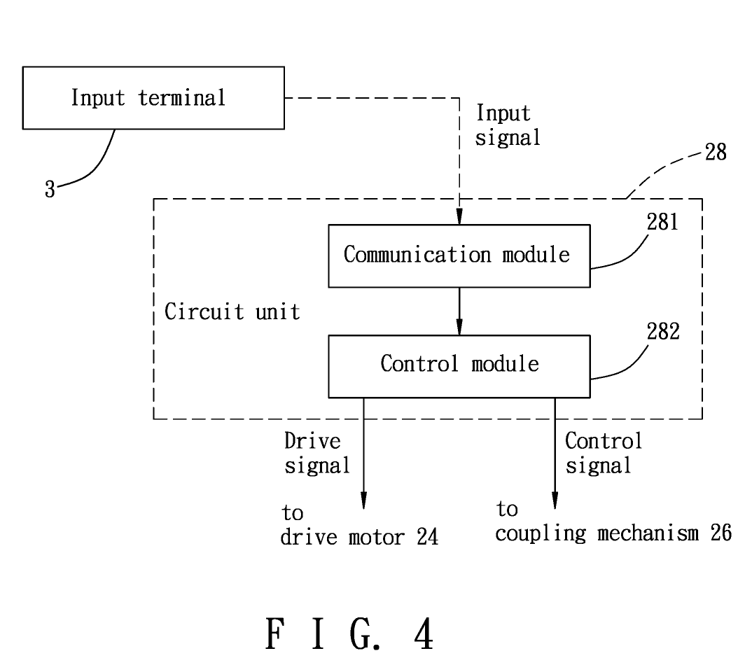

With further reference to FIGS. 3 and 4, the door lock controlling device 100 includes a belt 1, a rolling unit 2, and a circuit unit 28. The circuit unit 28 has a communication module 281 and a control module 282 electrically connected to the communication module 281.

In this embodiment, the door lock controlling device 100 can electrically communicate with an input terminal 3 via the communication module 281, and can be controlled by the input terminal 3. The input terminal 3 can be manually operated to generate an input signal, which can be transmitted to the door lock controlling device 100 via the communication module 281, to release locking of the door 200. The input terminal 3 is, but not limited to, a mobile communication device. It should be noted that in actual application, the electric communication method is not limited to that described above.

The belt 1 is adapted for extending around the push bar 201, and has a fixed end 11 that is adapted to be fixedly secured to the door 200, and a movable end 12 that is opposite to the fixed end 11. The fixed end 11 and the movable end 12 are adapted to be respectively located at opposite sides of the push bar 201.

The rolling unit 2 is adapted to be mounted to the door 200, and includes a mounting seat 21, a rolling member 22, a torsion spring 23, a drive motor 24, a planetary gear mechanism 25, a coupling mechanism 26, and two batteries 27.

The mounting seat 21 is adapted to be fixedly connected to the door 200. In this embodiment, the mounting seat 21 has a main body 211 and a partition plate 212. The main body 211 is formed with two insert holes 2111 spaced apart from each other, and defines a first receiving space 2112 in which the drive motor 24 and the coupling mechanism 26 are received, and two second receiving spaces 2113 in which the batteries 27 are received, respectively. The partition plate 212 has a plate body 2121, two insert pins 2122, and a spring-connecting rod 2123. The insert pins 2122 protrude from the plate body 2121 and are respectively inserted into the insert holes 2111 such that the partition plate 212 is securely coupled to the main body 211.

The rolling member 22 is connected to the movable end 12 of the belt 1, and is rotatable relative to the mounting seat 21 in a rotational direction (D1) (see

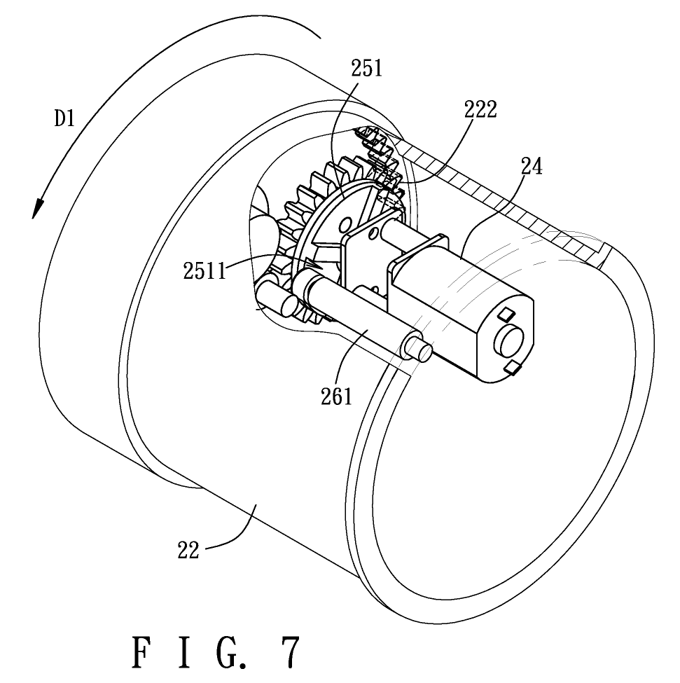

FIG. 7) to roll the belt 1 such that the push bar 201 is depressed by the belt 1 to the unlocked position. In this embodiment, the rolling member 22 is a barrel, and the movable end 12 of the belt 1 is securely connected to an outer surface of the barrel. The rolling member 22 has a ring gear portion 222 formed on an inner surface thereof, and a spring-engaging slot 221.

The torsion spring 23 has one end fixedly connected to the mounting seat 21 and an opposite end fixedly connected to the rolling member 22. Specifically, the one end of the torsion spring 23 is fixedly connected to the spring-connecting rod 2123 of the partition plate 212 of the mounting seat 21, and the opposite end of the torsion spring 23 engages the spring-engaging slot 221 of the rolling member 22.

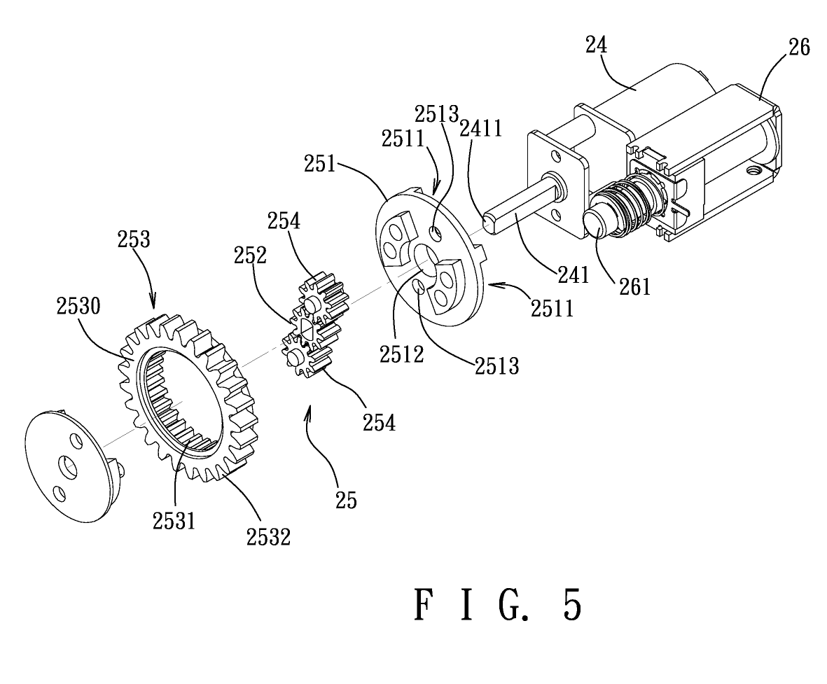

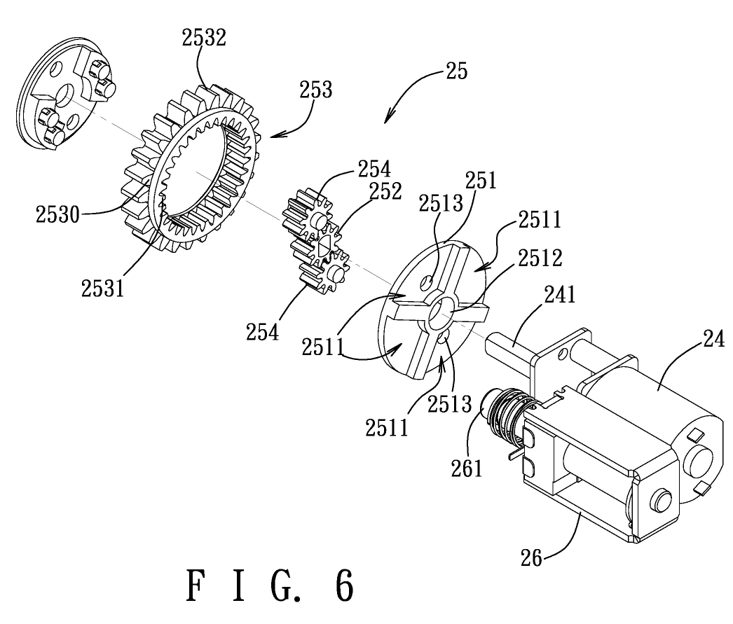

Referring to FIGS. 5 and 6, the drive motor 24 includes a rotatable drive shaft 241. The control module 282 of the circuit unit 28 is electrically connected to the drive motor 24 and the coupling mechanism 26, and is adapted to generate and output a drive signal to the drive motor 24 to drive rotation of the drive shaft 241 in response to the input signal generated by the input terminal 3.

The planetary gear mechanism 25 is connected between the rolling member 22 and the drive shaft 241, and includes a carrier 251, a sun gear 252, two planet gears 254, and a ring gear module 253.

The carrier 251 has a central hole 2512 through which the drive shaft 241 rotatably extends, two connecting holes 2513, and four retaining grooves 2511 that open toward the coupling mechanism 26. The sun gear 252 is co-rotatably coupled to an end portion 2411 of the drive shaft 241. The planet gears 254 engage respectively and rotatably the connecting holes 2513 of the carrier 251, and mesh with the sun gear 252. The ring gear module 253 includes a ring gear 2530 that surrounds the planet gears 254, that is connected to the rolling member 22, and that has an inner gear surface 2531 and an outer gear surface 2532. The inner gear surface 2531 meshes with the planet gears 254. The outer gear surface 2532 is formed with a plurality of teeth. The ring gear portion 222 of the rolling member 22 meshes with the teeth on the outer gear surface 2532 of the ring gear 2530.

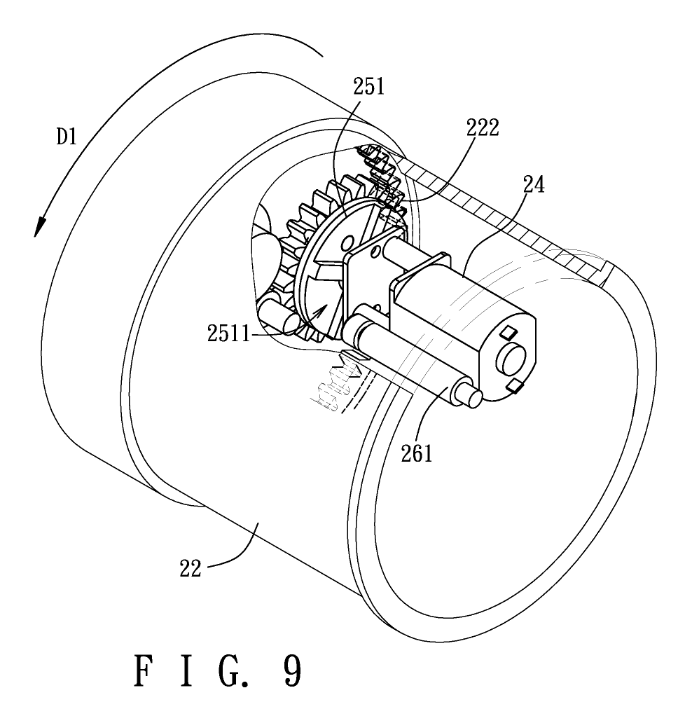

The coupling mechanism 26 includes a coupling member 261. The coupling mechanism 26 is operable between an engaging state (see FIG. 7), where the coupling mechanism 26 engages the planetary gear mechanism 25 such that the planetary gear mechanism 25 is driven operably by the drive shaft 241 to drive the rotation of the rolling member 22 in the rotational direction (D1), and a disengaging state (see FIG. 9), where the coupling mechanism 26 is disengaged from the planetary gear mechanism 25 such that rotation of the drive shaft 241 does not cause the rotation of the rolling member 22 in the rotational direction (D1). More specifically, when the coupling mechanism 26 is in the engaging state, the coupling member 261 is moved to engage one of the retaining grooves 2511 so that the carrier 251 is not allowed to rotate about the drive shaft 241. When the coupling mechanism 26 is in the disengaging state, the coupling member 261 is moved to be disengaged from the one of the retaining grooves 2511 for enabling rotation of the carrier 251 about the drive shaft 241.

In this embodiment, the coupling mechanism 26 is an electromagnetic valve, and the coupling member 261 is moved to engage with or be disengaged from the one of the retaining grooves 2511 in response to a control signal sent from the control module 282.

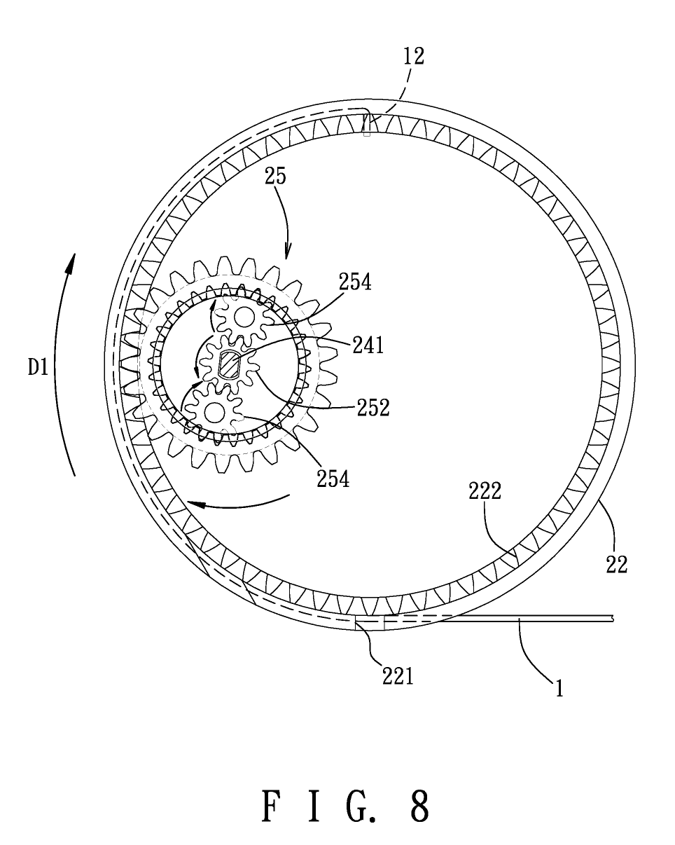

Referring to FIGS. 1, 6, 7, and 8, when the coupling mechanism 26 is in the engaging state, the door lock controlling device 100 is in an active mode, where the rolling member 22 is rotated to wind the belt 1 thereon, so that the push bar 201 is urged to be depressed to the unlocked position. Specifically, in the active mode, the drive signal is received by the drive motor 24 to rotate the drive shaft 241, and the sun gear 252 rotates together with the drive shaft 241 to drive rotation of the planet gears 254. At this time, since the carrier 251 is not rotatable about the drive shaft 241 due to engagement of the coupling member 261 in one of the retaining grooves 2511, positions of the planet gears 254 are fixed relative to the ring gear 2530, which means that the planet gears 254 cannot revolve around the sun gear 252 and can only rotate about their own axes (i.e., spin). Spinning of the planet gears 254 drives rotation of the ring gear 2530 to rotate the rolling member 22 in the rotational direction (D1), thereby winding the belt 1 on the rolling member 22 and moving the push bar 201 to the unlocked position. That is, when the coupling mechanism 26 is in the engaging state, the planet gears 254 are rotatable to drive the rotation of the rolling member 22 via the engagement between the planet gears 254 and the ring gear 2530 and the engagement between the ring gear 2530 and the rolling member 22.

Referring to FIGS. 1, 6, and 9, when the coupling mechanism 26 is in the disengaging state, the door lock controlling device 100 is in a passive mode, where the push bar 201 cannot be depressed to the unlocked position via the door lock controlling device 100 (i.e., via the belt 1 and the rotation of the rolling member 22), and has to be pushed manually to the unlocked position. In the passive mode, the carrier 251 is rotatable about the drive shaft 241 due to disengagement of the coupling member 261 in the one of the retaining grooves 2511. As such, when the sun gear 252 rotates together with the drive shaft 241, the planet gears 254 rotate and revolve around the sun gear 252. Under such epicyclic movement, the ring gear 2530 is stationary and does not rotate to drive rotation of the rolling member 22 in the rotational direction (D1). Therefore, the push bar 201 is not depressed and remains at the locked position.

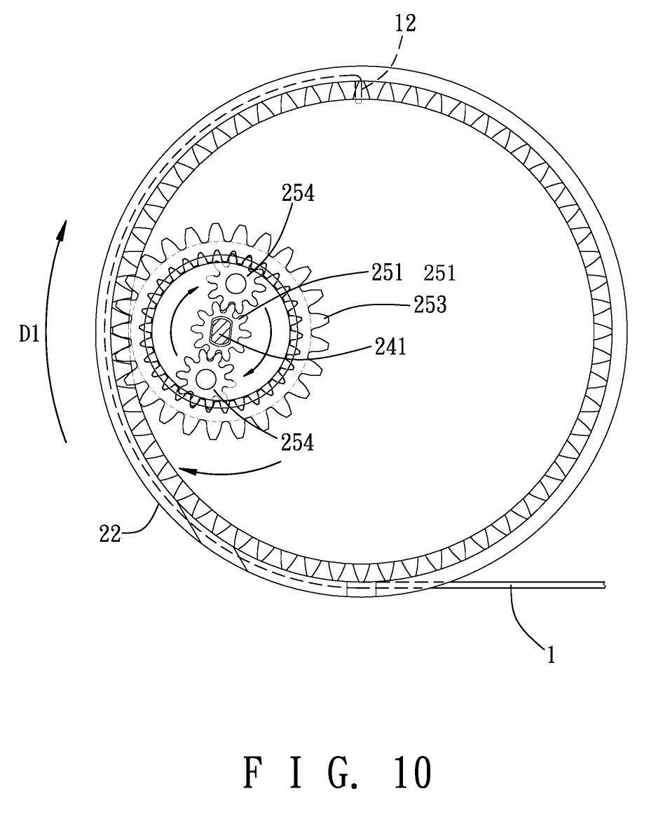

Referring to FIG. 10, it should be noted that when the coupling mechanism 26 is in the disengaging state and the input signal is not generated by the input terminal 3 (i.e., the drive shaft 241 is not driven to rotate), the push bar 201 can be pushed manually to the unlocked position. When an external pushing force is exerted on the push bar 201, the torsion spring 23 (see FIG. 3) biases the rolling member 22 to rotate in the rotational direction (D1) for stretching taut the belt 1. The rotation of the rolling member 22 rotates the ring gear 2530 and the planet gears 254. At this time, the drive shaft 241 and the sun gear 252 do not rotate, and the carrier 251 is rotatable about the drive shaft 241. Therefore, the planet gears 254 would only revolve around the sun gear 252 and would not further drive rotation of the rolling member 22 via the ring gear 2530.

When the external force is removed and the push bar 201 is moved back to the locked position, the rolling member 22 is reversely rotated. In a similar manner, the planet gears 254 would only revolve around the sun gear 252 and would not further drive rotation of the rolling member 22.

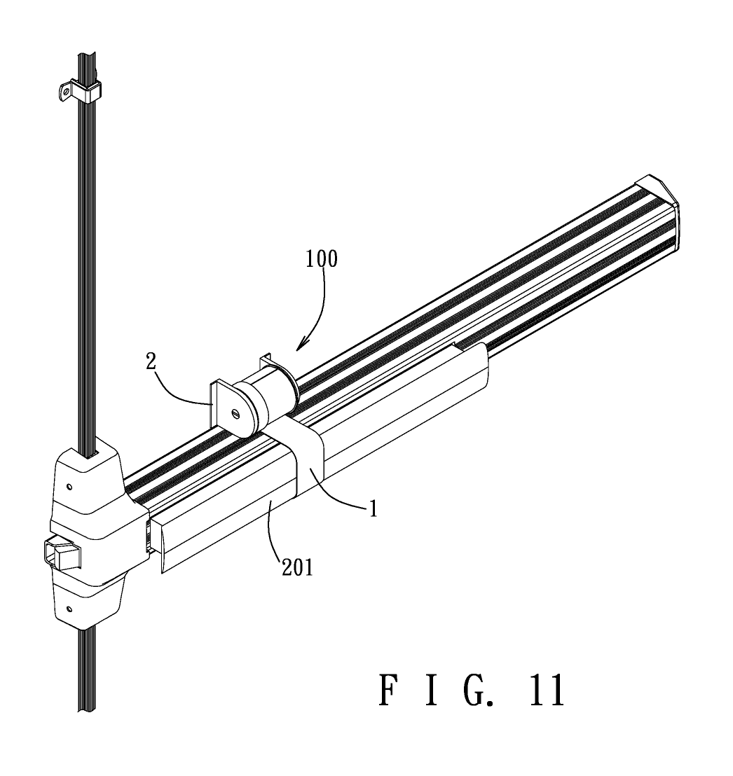

Referring to FIG. 11, the door lock controlling device 100 of the first embodiment can be employed in another type of push bar 201 as illustrated.

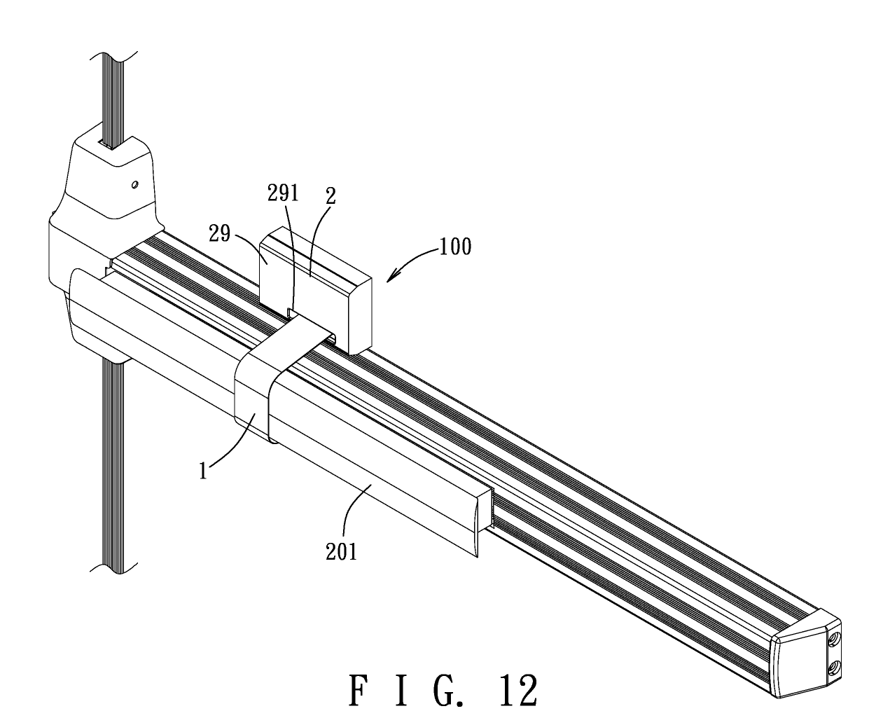

Referring to FIGS. 12 to 15, a second embodiment of the door lock controlling device 100 according to the disclosure is similar to the first embodiment. The differences between the first and second embodiments reside in the structures of the mounting seat 21, the rolling member 22, and the planetary gear mechanism 25 of the rolling unit 2.

In the second embodiment, the drive motor 24, the coupling mechanism 26, and the circuit unit 28 are disposed between the batteries 27 and the rolling member 22. However, the positions of the components of the rolling unit 2 are not limited thereto, and may be varied based on the configuration of the mounting seat 21.

The rolling member 22 of the second embodiment is a rotary shaft. The movable end 12 of the belt 1 is fixedly connected to the rotary shaft . It should be noted that the diameter of the rolling member 22 of the second embodiment (i.e., the rotary shaft) is smaller than that of the first embodiment (i.e., the barrel), thus the torque required for rotating the rolling member 22 of the second embodiment is smaller than that of the first embodiment. That is, it is easier for the rolling member 22 of the second embodiment to rotate about its own axis.

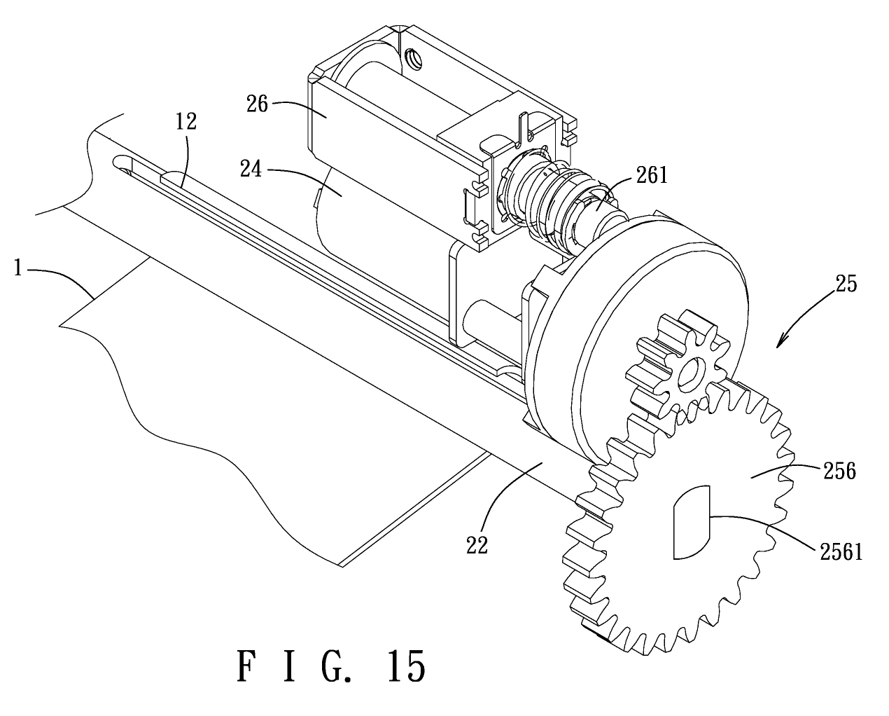

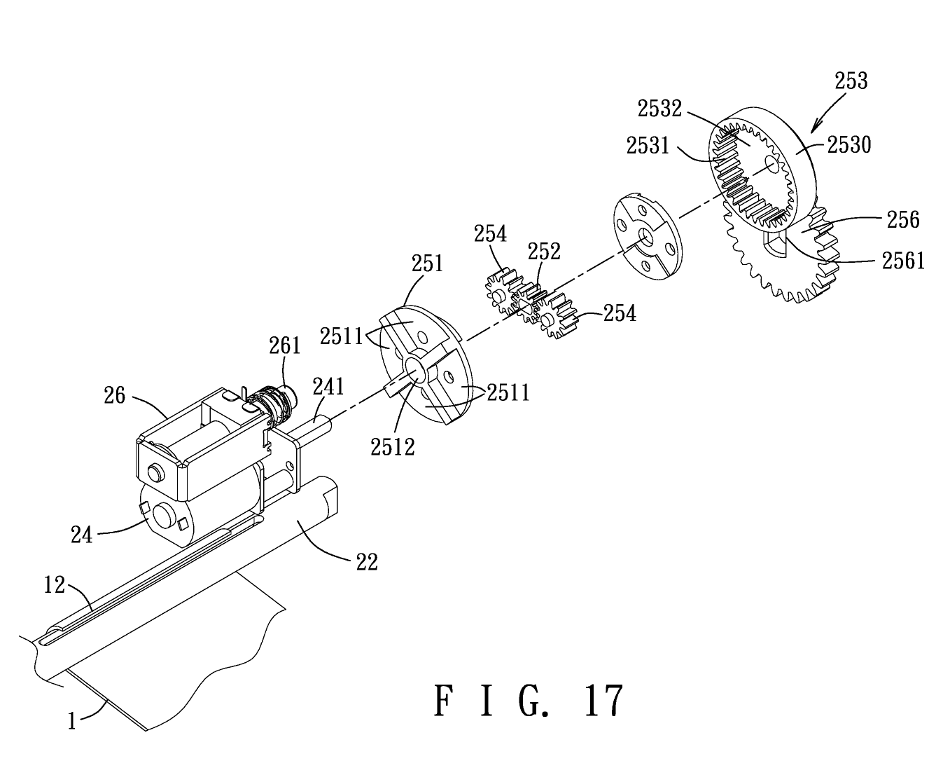

Referring to FIGS. 15 and 17, the ring gear module 253 of the second embodiment further includes a mounting wall 2532 co-rotatably connected to the ring gear 2530, a mounting gear 255 co-rotatably secured to the mounting wall 2532, and a transmission gear 256 fixedly secured to the rolling member 22 such that the rolling member 22 is co-rotatable with the transmission gear 256. Specifically, the transmission gear 256 is formed with a non-circular through hole 2561 into which an end portion of the rolling member 22 is fittingly inserted. The transmission gear 256 meshes with the mounting gear 255 such that, when the ring gear 2530 is rotated by the planet gears 254, the mounting gear 255 rotates to rotate the transmission gear 256 so as to drive the rotation of the rolling member 22.

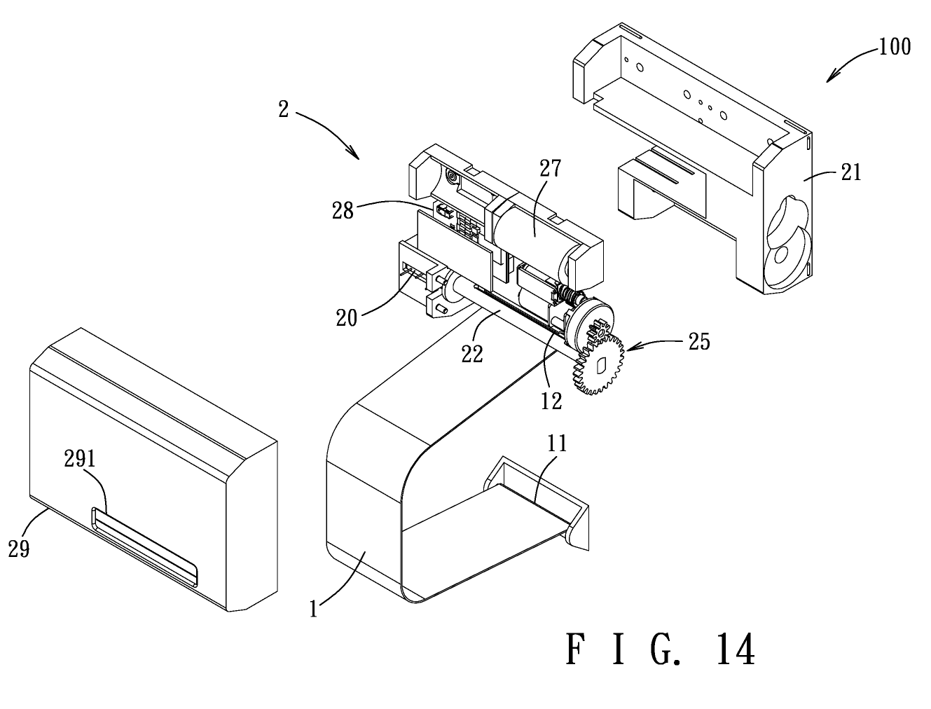

Referring back to FIG. 14, the rolling unit 2 of the second embodiment further includes a cover 29 being substantially cuboid, coupled to the mounting seat 21 and covering the components of the rolling unit 2. The cover 29 has an opening 291 through which the belt 1 extends, and which has a size larger than the cross section of the belt 1 so as to reduce friction between the belt 1 and the cover 29 during the winding and unwinding movements of the belt 1. In this embodiment, the door lock controlling device 100 of the second embodiment has a shape of a cigarette box.

The rolling unit 2 of the second embodiment further includes a variable resistor 20 connected to an end of the rolling member 22 opposite to the planetary gear mechanism 25. By monitoring the resistance of the variable resistor 20, the number of revolution of the rolling member 22 is known, which can be used to determine the extent of stretching of the belt 1.

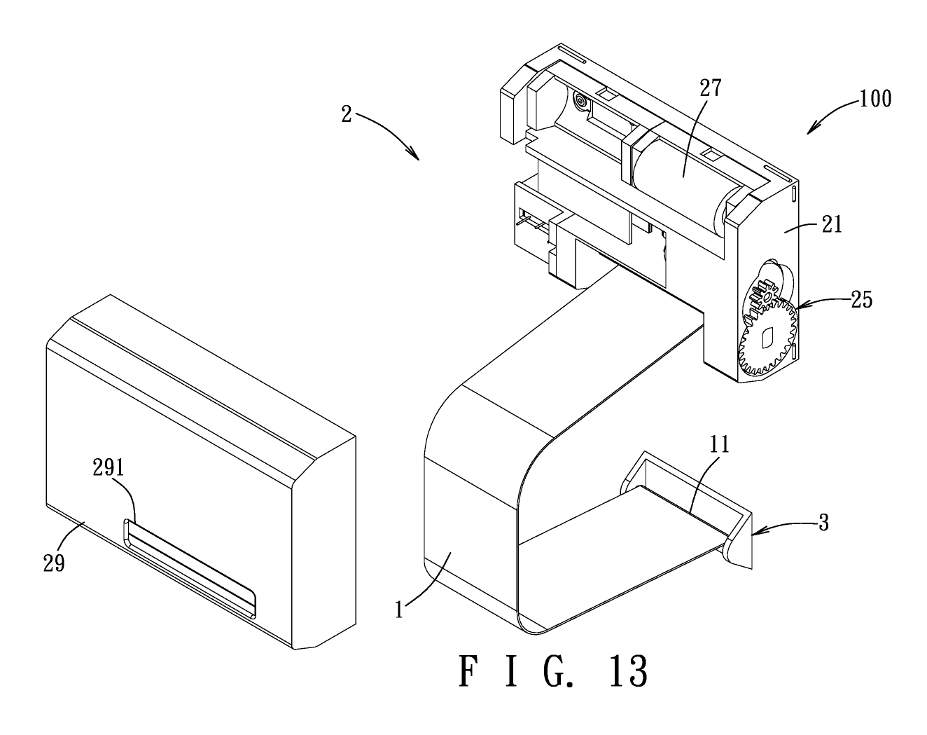

In the second embodiment, the fixed end 11 of the belt 1 is fixedly coupled to a fixed seat 3 (see FIG. 13) that is adapted to be fixedly mounted to the door 200 (see FIG. 2) and that is disposed below the rolling unit 2. It should be noted that the rolling unit 2 of the second embodiment may further include a torsion spring (not shown) that is similar to the torsion spring 23 (see FIG. 3) of the first embodiment, that has one end fixedly connected to the mounting seat 21 and an opposite end fixedly connected to the rolling member 22, and that biases the rolling member 22 to rotate in the rotational direction (D1) for stretching taut the belt 1.

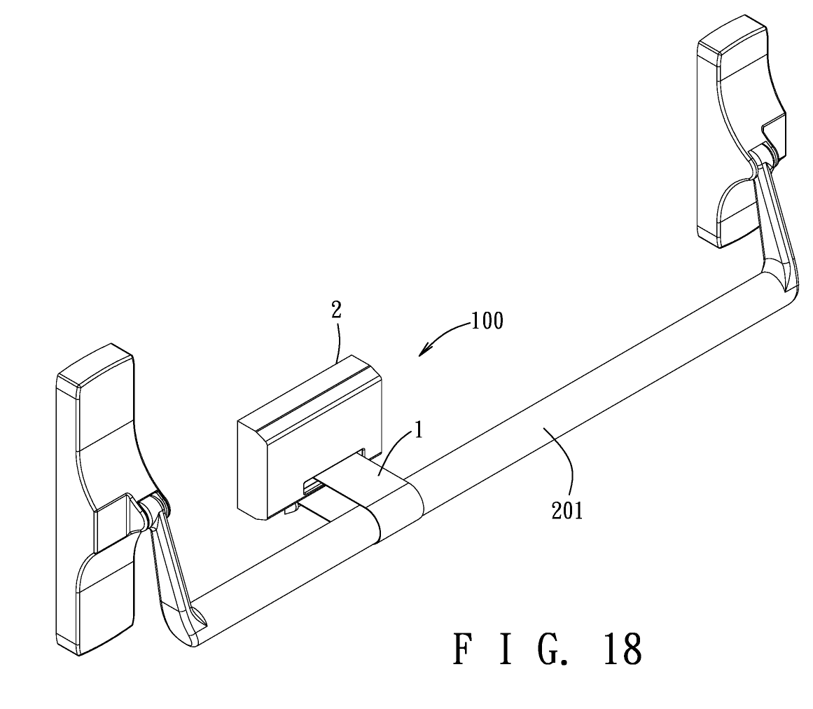

Referring to FIG. 18, the door lock controlling device 100 of the second embodiment can be employed in another type of push bar 201 (e.g., the same as that of FIG. 1) as illustrated.

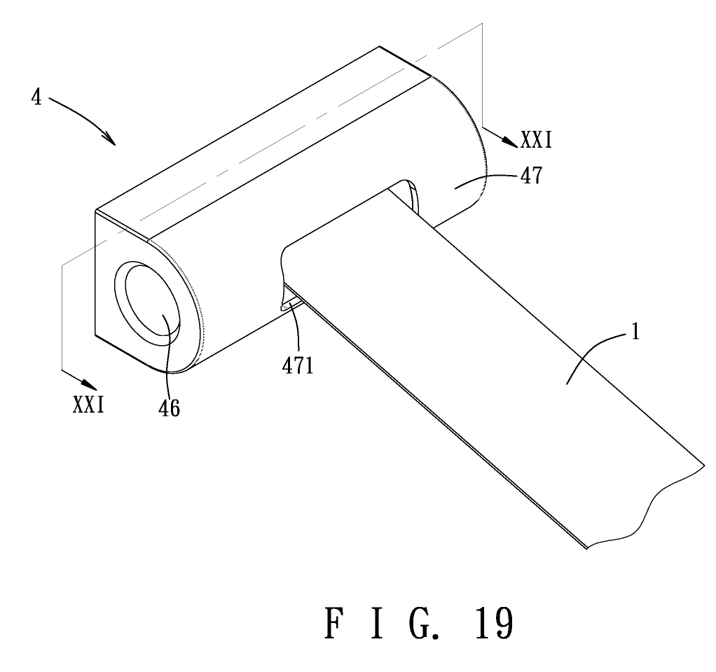

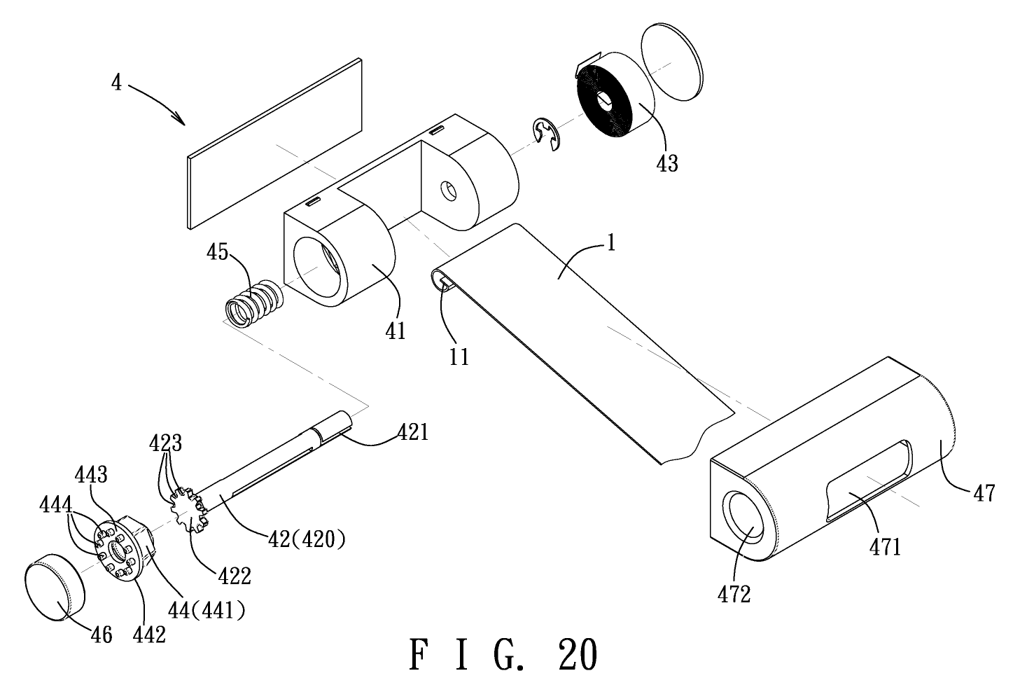

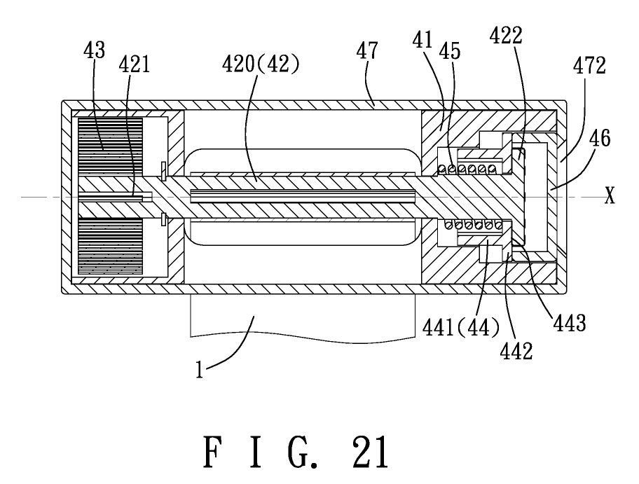

Referring to FIGS. 19 to 21, a third embodiment of the door lock controlling device 100 according to the disclosure is similar to the second embodiment. in the third embodiment, the fixed seat 3 (see FIG. 13) is omitted and is replaced by a fixed reel 4 that is adapted to be fixedly mounted to the door 200 (see FIG. 2) and that is disposed for winding the belt 1. The fixed reel 4 includes a base seat 41, a rotatable shaft 42, a torsion spring 43, a brake member 44, a resilient member 45, a press button 46, and a base seat cover 47.

The rotatable shaft 42 is disposed in the base seat 41, is rotatable about a shaft axis (X), and has a shaft body 420, a head 422 connected to the shaft body 420, and a spring-engaging slot 421 formed in an end portion of the shaft body 420 opposite to the head 422. The head 422 has an outer periphery formed with a plurality of angularly spaced-apart engaging grooves 423 that surround the shaft axis (X). The belt 1 is wound about the shaft body 420 of the rotatable shaft 42 with the fixed end 11 fixedly coupled to the shaft body 420.

The torsion spring 43 is disposed in the base seat 41, and has one end fixedly connected to the base seat 41 and the other end engaging the spring-engaging slot 421 of the rotatable shaft 42 for biasing the rotatable shaft 42 to rotate in a direction that winds the belt 1 about the rotatable shaft 42.

The brake member 44 has a tubular portion 441 sleeved on the shaft body 420 of the rotatable shaft 42, and a ring plate portion 442 connected to the tubular portion 441, and having an outer surface 443 configured with a plurality of angularly spaced-apart protrusions 444 that surround the shaft axis (X) and that are respectively engageable with the engaging grooves 423 of the head 422 of the rotatable shaft 42.

The resilient member 45 is configured as a compression spring, and is disposed in the base seat 41 for biasing the ring plate portion 442 of the brake member 44 toward the head 422 of the rotatable shaft 42. The press button 46 is disposed in the base seat 41 and is in contact with the outer surface 443 of the ring plate portion 442 of the brake member 44.

The base seat cover 47 covers the base seat 41, and is formed with a first opening 471 which has a size larger than the cross section of the belt 1 and through which the belt 1 extends, and a second opening 472 which corresponds in position to the press button 46 to expose the press button 46, and which is smaller than the press button 46 so that the press button 46 is confined between the base seat cover 47 and the ring plate portion 442 of the brake member 44.

When the press button 46 is not depressed (e.g., by a user), the ring plate portion 442 of the brake member 44 is urged by the resilient member 45 such that the outer surface 443 of the ring plate portion 442 abuts against the head 422 of the rotatable shaft 42, and that the protrusions 444 of the ring plate portion 442 respectively engage the engaging grooves 423 of the head 422 so as to arrest rotation of the rotatable shaft 42 against a biasing force of the torsion spring 43. When it is desired to wind the belt 1, the press button 46 can be depressed against a biasing force of the resilient member 45 so as to allow the protrusions 444 of the ring plate portion 442 of the brake member 44 to be respectively disengaged from the engaging grooves 423 of the head 422 of the rotatable shaft 42, so that the torsion spring 43 biases the rotatable shaft 42 to rotate for winding the belt 1.

It is worth mentioning that the fixed reel 4 can be also employed in the first embodiment. The change in the amount of the belt 1 which is wound about the rolling member 22 during operation of the door lock control device 100 would not significantly increase or decrease the torque required to rotate the rolling member 22. That is, during use, since most of the belt 1 is wound about the rotatable shaft 42 of the fixed reel 4, the power output required to rotate the rolling member 22 would not be changed by a significant amount. By the design of the fixed reel 4, the whole belt 1 can be first wound about the rotatable shaft 42 of the fixed reel 4 during manufacturing, and then the belt 1 can be pulled to be connected to the rolling member 22 during assembly of the door lock control device 100, thereby improving convenience during assembly.

In summary, by virtue of the rolling member 22, the planetary gear mechanism 25, the coupling mechanism 26, and the drive motor 24, the push bar 201 can be depressed to the unlocked position in a convenient manner. The door lock controlling device 100 can be operated in the active mode and in the passive mode to satisfy different needs. In addition, the door lock control device 100 can be controlled by the input terminal 3, which enables remote lock release.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A door lock controlling device adapted to be disposed between a door and a push bar which is mounted on the door, the push bar being operable between a locked position, where the push bar is distal from the door and the door is locked, and an unlocked position, where the push bar is proximate to the door to release locking of the door, said door lock controlling device comprising:
a belt adapted for extending around the push bar, and having a fixed end that is adapted to be fixedly secured to the door, and a movable end that is opposite to said fixed end, said fixed end and said movable end being adapted to be respectively located at opposite sides of the push bar; and
a rolling unit adapted to be mounted to the door, and including a rolling member that is connected to said movable end of said belt, and that is rotatable in a rotational direction to roll the belt such that the push bar is depressed by said belt to the unlocked position.

2. The door lock controlling device as claimed in claim 1, wherein said rolling unit further includes a mounting seat that is adapted to be fixedly connected to the door, and a torsion spring that has one end fixedly connected to said mounting seat and an opposite end fixedly connected to said rolling member, and that biases said rolling member to rotate in the rotational direction for stretching taut said belt.

3. The door lock controlling device as claimed in claim 1, wherein said rolling unit further includes:
a drive motor that includes a rotatable drive shaft;
a planetary gear mechanism that is connected between said rolling member and said drive shaft; and
a coupling mechanism operable between an engaging state, where said coupling mechanism engages said planetary gear mechanism such that said planetary gear mechanism is driven operably by said drive shaft to drive the rotation of said rolling member in the rotational direction, and a disengaging state, where said coupling mechanism is disengaged from said planetary gear mechanism such that rotation of said drive shaft does not cause the rotation of said rolling member in the rotational direction.

4. The door lock controlling device as claimed in claim 3, wherein said planetary gear mechanism includes:
a carrier having a central hole, said drive shaft extends rotatably through said central hole;
a sun gear co-rotatably coupled to said drive shaft;
a plurality of planet gears rotatably connected to said carrier and meshing with said sun gear; and
a ring gear module including a ring gear that surrounds said planet gears, that is connected to said rolling member, and that has an inner gear surface meshing with said planet gears such that, when said coupling mechanism is in the engaging state, said planet gears are rotatable to drive the rotation of said rolling member via said ring gear.

5. The door lock controlling device as claimed in claim 4, wherein:
said carrier further has at least one retaining groove that opens toward said coupling mechanism;
said coupling mechanism includes a coupling member;
when said coupling mechanism is in the engaging state, said coupling member is moved to engage said at least one retaining groove so that said carrier is not allowed to rotate about said drive shaft; and
when said coupling mechanism is in the disengaging state, said coupling member is moved to be disengaged from said at least one retaining groove for enabling rotation of said carrier about said drive shaft.

6. The door lock controlling device as claimed in claim 5, wherein said coupling mechanism is an electromagnetic valve.

7. The door lock controlling device as claimed in claim 6, wherein:
said drive motor drives rotation of said drive shaft in response to a drive signal; and
said door lock controlling device further comprises a control module that is electrically connected to said drive motor and that is adapted to generate and output the drive signal to said drive motor in response to an input signal.

8. The door lock controlling device as claimed in claim 4, wherein said ring gear of said ring gear module further has an outer gear surface formed with a plurality of teeth, said rolling member having a ring gear portion that meshes with said teeth on said outer gear surface of said ring gear such that, when said coupling mechanism is in the engaging state, said planet gears are rotatable to drive the rotation of said rolling member via the engagement between said planet gears and said ring gear and the engagement between said ring gear and said rolling member.

9. The door lock controlling device as claimed in claim 8, wherein said rolling member is a barrel.

10. The door lock controlling device as claimed in claim 9, wherein said rolling unit further includes a mounting seat that is adapted to be fixedly connected to the door, and a torsion spring that has one end fixedly connected to said mounting seat and an opposite end fixedly connected to said rolling member, and that biases said rolling member to rotate in the rotational direction for stretching taut said belt.

11. The door lock controlling device as claimed in claim 4, wherein said ring gear module further includes a mounting wall co-rotatably connected to said ring gear, a mounting gear co-rotatably secured to said mounting wall, and a transmission gear fixedly secured to said rolling member such that said rolling member is co-rotatable with said transmission gear, said transmission gear meshing with said mounting gear such that, when said ring gear is rotated by said planet gears, said mounting gear rotates to rotate said transmission gear so as to drive the rotation of said rolling member.

12. The door lock controlling device as claimed in claim 11, wherein said rolling member is a rotary shaft.

13. The door lock controlling device as claimed in claim 1, further comprising a fixed reel adapted to be fixedly mounted to the door, said fixed reel including
a base seat;
a rotatable shaft that is coupled to said fixed end of said belt, that is rotatable about a shaft axis, and that has a spring-engaging slot; and
a torsion spring that is disposed in said base seat, and that has one end fixedly connected to said base seat and the other end engaging said spring-engaging slot of said rotatable shaft for biasing said rotatable shaft to rotate in a direction that winds said belt.

14. The door lock controlling device as claimed in claim 13, wherein:
said rotatable shaft further has a shaft body, and a head connected to said shaft body and having an outer periphery that is formed with a plurality of angularly spaced-apart engaging grooves surrounding the shaft axis; and
said fixed reel further includes a brake member having a tubular portion that is sleeved on said shaft body of said rotatable shaft, and a ring plate portion that is connected to said tubular portion, and that has an outer surface configured with a plurality of angularly spaced-apart protrusions, said protrusions surrounding the shaft axis, and being respectively engageable with said engaging grooves of said head of said rotatable shaft for arresting rotation of said rotatable shaft against a biasing force of said torsion spring.

15. The door lock controlling device as claimed in claim 14, wherein said fixed reel further includes:
a resilient member that is disposed in said base seat for biasing said ring plate portion of said brake member toward said head of said rotatable shaft so that said protrusions respectively engage said engaging grooves; and
a press button that is disposed in said base seat and that is in contact with said outer surface of said ring plate portion of said brake member, such that when said press button is depressed against a biasing force of said resilient member, said protrusions are respectively disengaged from said engaging grooves so as to allow said torsion spring to bias said rotatable shaft to rotate in the direction that winds said belt.

16. The door lock controlling device as claimed in claim 15, wherein said fixed reel further includes a base seat cover that covers said base seat, and that is formed with a first opening through which said belt extends, and a second opening which corresponds in position to said press button to expose said press button, and which is smaller than said press button so that said press button is confined between said base seat cover and said ring plate portion of said brake member.
